(19) United States
(12) Patent Application Publication
(10) Pub. No.: US 2015/0185861 A1
(43) Pub. Date: Jul. 2, 2015

(54) Phonetic Symbol Based Chinese Input Method for Computer by Using Word Prediction and Apparatus Thereof

(71) Applicants: Wen-Guei Yang, Kaohsiung City (TW); Yu-Han Yang, Kaohsiung City (TW)

(72) Inventors: Wen-Guei Yang, Kaohsiung City (TW); Yu-Han Yang, Kaohsiung City (TW)

(21) Appl. No.: 14/146,087

(22) Filed: Jan. 2, 2014

(51) Int. Cl. G06F 3/01; G06F 3/023

(52) U.S. Cl. CPC G06F 3/018; G06F 3/0237

(57) ABSTRACT

A phonetic symbol based Chinese input method for computer and apparatus thereof is provided. The method includes pressing keys to enter a numeric string corresponding to a set of phonetic symbols wherein each key represents one of 0 to 9; activating a piece of software to assign the set of phonetic symbols to a corresponding numeric string wherein the piece of software divides the string into a symbol zone and a tone zone; wherein the symbol zone includes one or two consonants, zero, one or two rhymes or zero, one or two compound rhymes; activating a Chinese characters output module to receive the string by using word prediction based on frequently used Chinese characters wherein the numeric string has numerals corresponding to the set of phonetic symbols; searching a Chinese characters database to find matched Chinese character(s); outputting the matched Chinese character(s); and returning to beginning.

### BACKGROUND OF THE INVENTION

1. Field of the Invention

The invention relates to Chinese input methods for computers and more particularly to a phonetic symbol (Zhuyin) based Chinese input method for computer by using word prediction based on frequently used Chinese characters and apparatus thereof so that a corresponding Chinese character or Chinese phrase can be shown on a display by keying in a minimum number of phonetic symbol(s), thereby increasing the input rate.

2. Description of Related Art

A conventional phonetic symbol based Chinese input method implemented on a digital electronic device including a keyboard, a storage medium, and a display. The device has a keystroke signal corresponding to a set of phonetic symbols based on a predetermined Chinese character pool. Each digit is associated with a portion of all combinations of phonetic symbols. A set of three rhymes are associated with a key. Each set has two vowels of two rhymes. One set two vowels of one rhyme. One set has two vowels of one tone which is selectively associated with the other key. The storage medium includes a dictionary having phonetic symbols. Each phonetic symbol has a single Chinese character or a phrase which in turn corresponds to a phonetic symbol.

The method comprises the steps of: (1) generating a keystroke signal in response to a pressed key; (2) finding a set of phonetic symbols corresponding to the keystroke signal; (3) selecting a phonetic symbol from the set of phonetic symbols or a corresponding tone based on the number of keystrokes and possible combinations of

Chinese characters; (4) determining whether the selected one is a phonetic symbol or a tone in which the step returning to step (1) if the selected one is a phonetic symbol; (5) searching a dictionary to find a corresponding Chinese character or phrase based on the inputted phonetic symbol; (6) sending the found Chinese character or phrase to the display; and (7) returning to step (1) if no stop command is received.

However, it is often that there are many keystroke signals to be inputted and there is no rule for user reference. Thus, the conventional Chinese input method and device are not desirable and the need for improvement still exists.

### SUMMARY OF THE INVENTION

It is therefore one object of the invention to provide a phonetic symbol based Chinese input apparatus for a computer comprising a main device; a keyboard having a plurality of numerals each representing one of 0 to 9; and a display; wherein the main device includes a storage medium, and a piece of software for assigning entered phonetic symbols including a consonant, one of a rhyme and a compound rhyme, and a tone to a corresponding numeric string by using word prediction based on frequently used Chinese characters so that a corresponding Chinese character or Chinese phrase is shown on the display by keying in a minimum number of phonetic symbols.

It is another object of the invention to provide a phonetic symbol based Chinese input method for a computer comprising the steps of (1) pressing a plurality of keys of a keyboard to enter a numeric string corresponding to a set of phonetic symbols wherein each of the keys represents 0, 1, 2, 3, 4, 5, 6, 7, 8, or 9; (2) activating a piece of software to assign the set of phonetic symbols to a corresponding numeric string wherein the piece of software divides the corresponding numeric string into a symbol zone and a tone zone; wherein the symbol zone comprises one or two consonants, zero, one or two rhymes or zero, one or two compound rhymes; and wherein the tone zone comprises a tonal mark; (3) activating a Chinese characters output module to receive the typed numeric string by using word prediction based on frequently used Chinese characters wherein the numeric string has numerals corresponding to the set of phonetic symbols; (4) searching one or more corresponding Chinese characters from a Chinese characters database by comparing the set of phonetic symbols with phonetic symbols of each of a plurality of Chinese characters stored in the Chinese characters database; (5) outputting the one or more corresponding Chinese characters if the searching is positive; and (6) returning to step (1) to wait for input if no stop command is received.

The above and other objects, features and advantages of the invention will become apparent from the following detailed description taken with the accompanying drawings.

### BRIEF DESCRIPTION OF THE DRAWINGS

FIG. 1 is a phonetic symbol table according to the invention;

FIG. 2 is a table showing consonants rhymes, and compound rhymes according to the invention;

FIG. 3 is a table showing 22 compound rhymes according to the invention;

FIG. 4 schematically depicts an order of combining consonants, rhymes, and tones according to the invention;

FIG. 5 is a table of tones according to the invention;

FIG. 6 is a phonetic symbol table without the [symbol] according to the invention;

FIG. 7 is a table without the [symbol] according to the invention;

FIG. 8 is a block diagram of a phonetic symbol based Chinese input apparatus for computer according to the invention; and

FIGS. 9A to 9Q are tables containing 1344 combinations of phonetic symbols, their tones, and codes according to the invention.

### DETAILED DESCRIPTION OF THE INVENTION

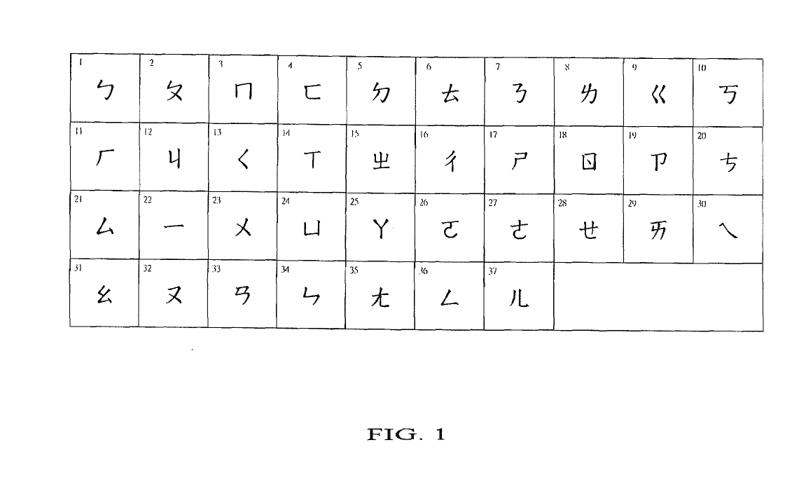

Referring to FIGS. 1 to 7, a phonetic symbol based Chinese input method for computer in accordance with the invention is illustrated. The method comprises the following steps:

(1) tabulating all phonetic symbols in a phonetic symbol table wherein each of the phonetic symbols is associated with a numeral between 1 and 37 (see FIG. 1);

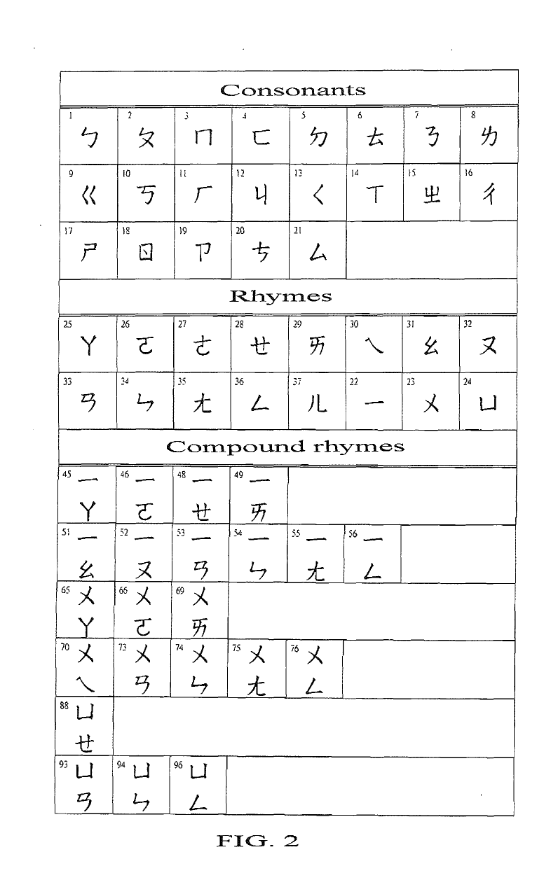

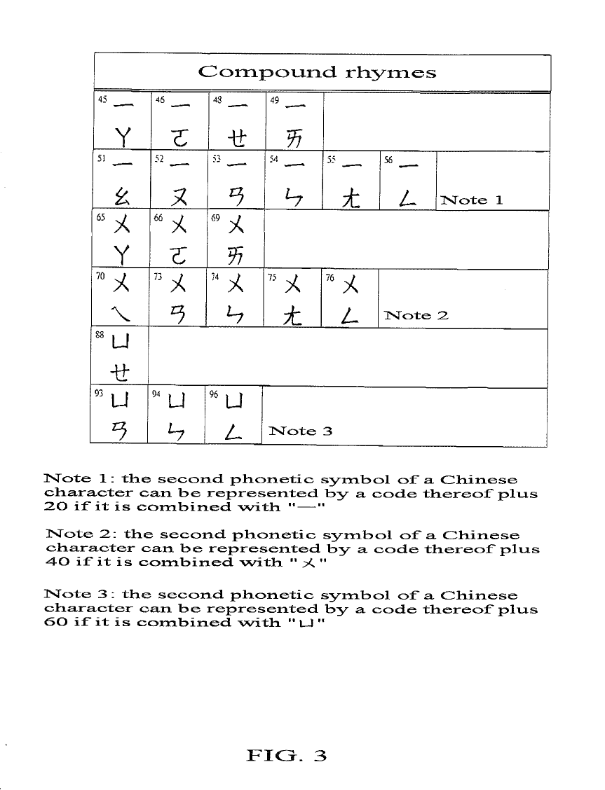

(2) dividing the phonetic symbols into a first zone including 21 consonants and a second zone including 16 rhymes, and combining the rhymes as 22 compound rhymes with a total of 59 characters (see FIG. 2) wherein the 22 compound rhymes are further shown in a table of FIG. 3;

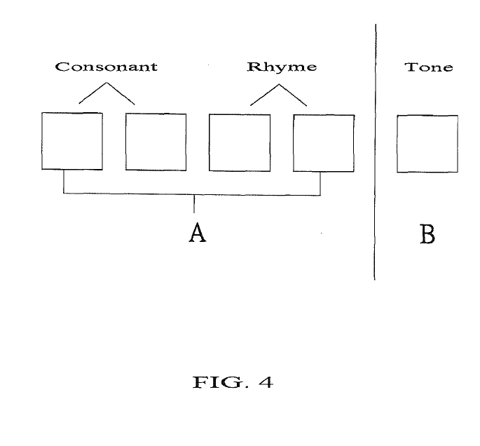

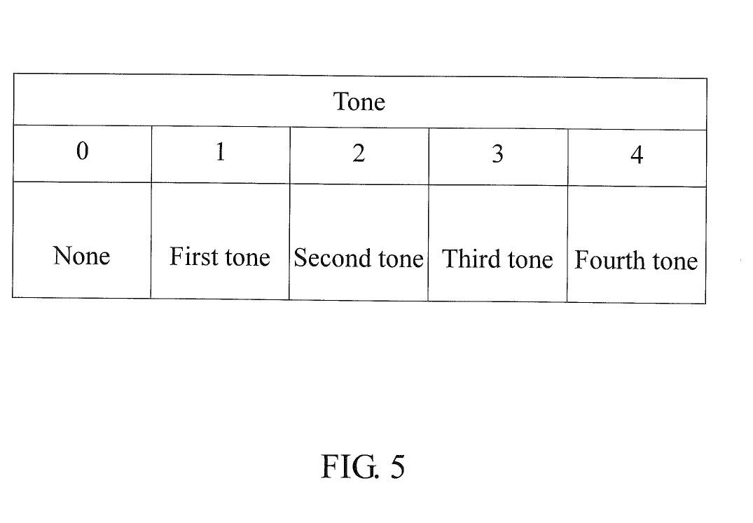

(3) dividing inputted phonetic symbols into a symbol zone A including a consonant and a rhyme, and a tone zone B (see FIG. 4) wherein the symbol zone A comprises one, two, three, or four symbols, the symbol zone B comprises a tonal mark having a tone number 0 representing none, a tone number 1 representing first tone, a tone number 2 representing second tone, a tone number 3 representing third tone, and a tone number 4 representing fourth tone (see FIG. 5);

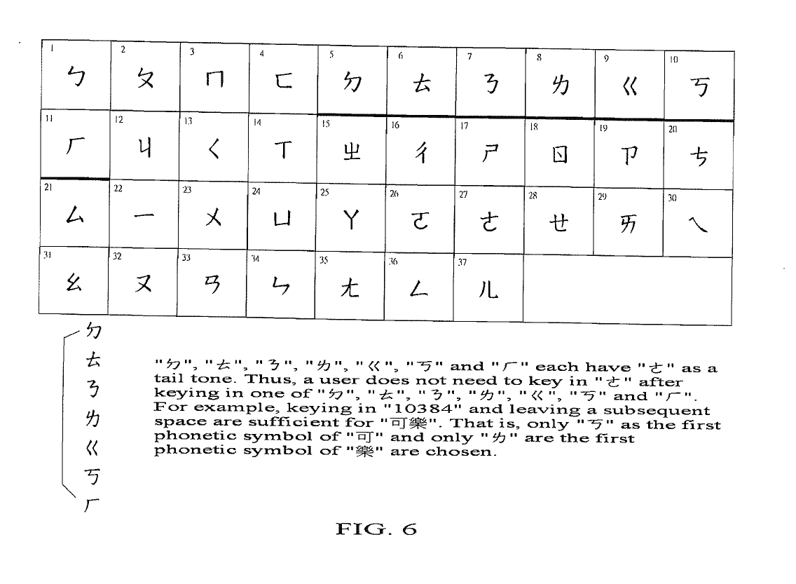

(4) omitting “ [symbol] ” from [symbol] and “ [symbol] ” when they are combined with “ [symbol] ” because they have “ [symbol] ” as a tail tone (see FIG. 6);

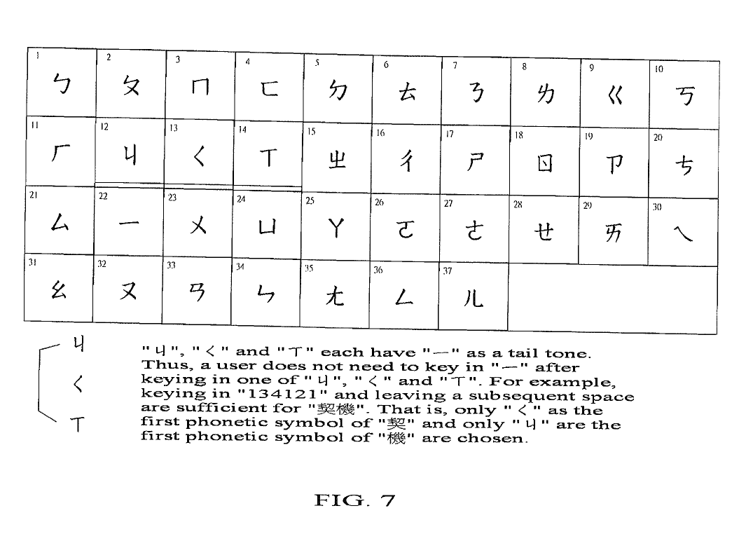

(5) omitting “ [symbol] ” from “ [symbol] ” and “ [symbol] ” when they are combined with “ [symbol] ” because they have “ [symbol] ” as a tail tone (see FIGS. 7); and

(6) replacing [symbol] , [symbol] and “ [symbol] ” with numerals 0, 1, 2, 3, 4, 5, 6, 7, 8 and 9 respectively.

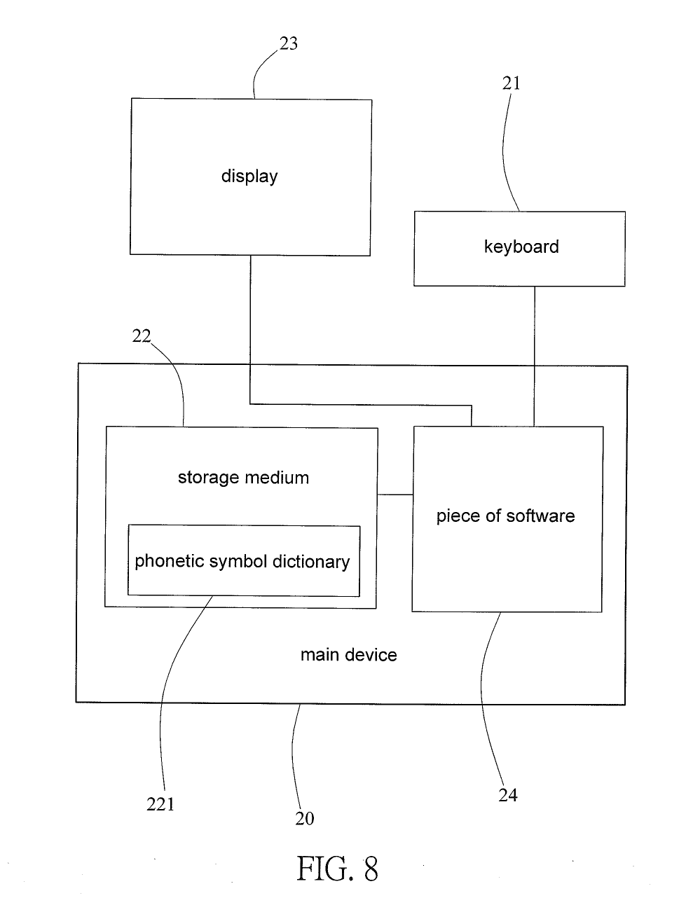

Referring to FIG. 8 in conjunction with FIGS. 1 to 7, a phonetic symbol based Chinese input apparatus for computer in accordance with the invention is shown. The apparatus comprises a main device 20; a keyboard 21 having keys each representing one of 0 to 9, and a display 23. The main device 20 includes a storage medium 22 and a piece of software 24 for assigning entered phonetic symbols including a consonant, a rhyme (or a compound rhyme), and a tone to a corresponding string. The storage medium 22 is a data storage device and has a phonetic symbol dictionary 221. The phonetic symbol dictionary 221 comprises a first Chinese characters output module having a plurality of phonetic symbols each corresponding to a Chinese character, a second Chinese characters output module having a plurality of phonetic symbols each corresponding to a phrase by using word prediction based on frequently used Chinese characters, and a Chinese characters data base.

The first Chinese characters output module has a plurality of stored phonetic symbols. Each phonetic symbol corresponds to a unique Chinese character. The second Chinese characters output module has a plurality of stored phonetic symbols by using word prediction based on frequently used Chinese characters. Each phonetic symbol corresponds to a phrase as detailed below.

[symbol] and “ [symbol] ” each have “ [symbol] ” as a tail tone. Thus, a user does not need to key in “ [symbol] ” after keying in one of [symbol] and “ [symbol] ”. This can save one data entering operation, i.e., reducing the number of keying in.

[symbol] and “ [symbol] ” each have “ [symbol] ” as a tail tone. Thus, a user does not need to key in “ [symbol] ” after keying in one of [symbol] and “ [symbol] ”. This can save one data entering operation, i.e., reducing the number of keying in.

[symbol] [symbol] and “ [symbol] ” are replaced with numerals 0, 1, 2, 3, 4, 5, 6, 7, 8 and 9 respectively.

String “19314224” represents “ [symbol] ”. Advantageously, “ [symbol] ” will appear after typing “193144” and leaving a subsequent space. That is, it reduces the number of keying in by two. This is an exemplary example of keying in reduction of two Chinese characters.

String “329453518312” represents “ [symbol] ” in which “3294” represents “ [symbol] ”, “5351” represents “ [symbol] ”, and “8312” represents “ [symbol] ” respectively. Advantageously, “ [symbol] [symbol] ” will appear after typing “345182” and leaving a subsequent space. That is, only the first phonetic symbol and the tone of each Chinese character are required to key in, thereby reducing the number of keying in by six. This is an exemplary example of keying in reduction of three Chinese characters.

String “15761116523429662” represents “ [symbol] ”. Advantageously, “ [symbol] ” will appear after typing “1511392” and leaving a subsequent space. That is, only the first phonetic symbol of each Chinese character and the tone of the last Chinese character are required to key in, thereby reducing the number of keying in by 11. This is an exemplary example of keying in reduction of four Chinese characters.

String “1256116362216631541254117270210291” represents “ [symbol] ”. [symbol] . Advantageously, “ [symbol] [symbol] ” will appear after typing “121621101” and leaving a subsequent space. That is, only the first phonetic symbol of each of the first three Chinese characters and the first phonetic symbol of the last Chinese character, and the tone of the last Chinese character are required to key in, thereby reducing the number of keying in. This is an exemplary example of keying in reduction of multiple Chinese characters.

The Chinese characters data base stores a plurality of phonetic symbols each correspond to a single Chinese characters or a phrase.

The method comprises the steps of:

(1) pressing keys of a keyboard 21 to enter a numeric string corresponding to a set of phonetic symbols;

(2) activating a piece of software 24 to assign entered phonetic symbols to a corresponding numeric string having a number consisting of at least one of 0 to 9. In detail, after receiving entered phonetic symbols and assigning it to a corresponding string of numerals, the piece of software 24 divides the string into a symbol zone and a tone zone wherein the symbol zone comprises consonant(s) and rhyme(s). In detail, there are one or two consonants and there are 0, 1 or 2 rhymes or there are 0, 1 or two compound rhymes. The tone zone comprises a tonal mark;

(3) activating a Chinese characters output module to receive the typed string by using word prediction based on frequently used Chinese characters wherein the string contains numerals corresponding to phonetic symbols;

(4) searching corresponding Chinese characters(s) from a Chinese characters database by comparing with phonetic symbols of entries in the Chinese characters database and outputting the corresponding Chinese characters if the searching is positive wherein the outputted Chinese characters are sent to the display 23; and

(6) returning to step (1) to wait for input if no stop command is received.

Regarding each string, it comprises one or two consonants, zero to two rhymes or compound rhymes, and one tone. The consonants are “ [symbol] ” to “ [symbol] ” and are represented by numerals 1 to 21. The rhymes are “ [symbol] ” to “ [symbol] ” and are represented by numerals 22 to 37. Code of the rhyme is added by 20 when combining with “ [symbol] ” to become a compound rhyme. Code of the rhyme is added by 40 when combining with “ [symbol] ” to become a compound rhyme. The tonal mark has a tone number 0 representing none, a tone number 1 representing first tone, a tone number 2 representing second tone, a tone number 3 representing third tone, and a tone number 4 representing fourth tone.

The phonetic symbol based Chinese input method for computer of the invention is implemented on an apparatus comprising a main device; a keyboard having numerals 0 to 9, and a display. The main device includes a storage medium and a piece of software for assigning entered phonetic symbols including a consonant, a rhyme (or a compound rhyme), and a tone to a corresponding string. The storage medium has a phonetic symbol dictionary. The phonetic symbol dictionary comprises a Chinese characters output module having a plurality of phonetic symbols each corresponding to a phrase by using word prediction based on frequently used

Chinese characters, and a Chinese characters data base. As a result, a Chinese characters or a Chinese phrase is shown on the display in response to keying in at least one phonetic symbol.

As shown in FIG. 1 specifically, it shows a phonetic symbol table according to the invention. The phonetic symbols are classified as consonants and rhymes. A number is assigned to each of the consonants and the rhymes. For each Chinese characters, it comprises one or two consonants, zero to two rhymes or compound rhymes, and one tone.

As shown in FIG. 6 specifically, it is a phonetic symbol table without the “ [symbol] ” according to the invention. In detail, “ [symbol] ” and “ [symbol] ” each have “ [symbol] ” as a tail tone. Thus, a user does not need to key in “ [symbol] ” after keying in one of “ [symbol] ”, [symbol] For example, keying in “52” is sufficient for [symbol] keying in “64” is sufficient for [symbol] and keying in “10384” and leaving a subsequent space are sufficient for “ [symbol] ”.

As shown in FIG. 7 specifically, it is a table without the “ [symbol] ” according to the invention. In detail, “ [symbol] ” and “ [symbol] ” each have “ [symbol] ” as a tail tone. Thus, a user does not need to key in “ [symbol] ” after keying in one of [symbol] and “ [symbol] ”. For example, keying in “122” is sufficient for “ [symbol] ”, and keying in “7144” is sufficient for “ [symbol] ”.

As shown in FIG. 3 specifically, it is a table showing 22 compound rhymes according to the invention. In detail, there is a Chinese characters having phonetic symbols with a first phonetic symbol being one of [symbol] and “ [symbol] ”. For the phonetic symbols of the Chinese characters, the second phonetic symbol thereof can be represented by a code thereof plus 20 if it is combined with “ [symbol] ”; the second phonetic symbol thereof can be represented by a code thereof plus 40 if it is combined with “ [symbol] ”, and the second phonetic symbol thereof can be represented by a code thereof plus 60 if it is combined with “ [symbol] ”.

For phonetic symbols “ [symbol] ”, keying in “54” is sufficient because code of “ [symbol] ” is 34 and 34 plus 20 equals 54. For phonetic symbols “ [symbol] ”, keying in “74” is sufficient because code of “ [symbol] ” is 34 and 34 plus 40 equals 74. For phonetic symbols “ [symbol] ”, keying in “94” is sufficient because code of “ [symbol] ” is 34 and 34 plus 60 equals 94.

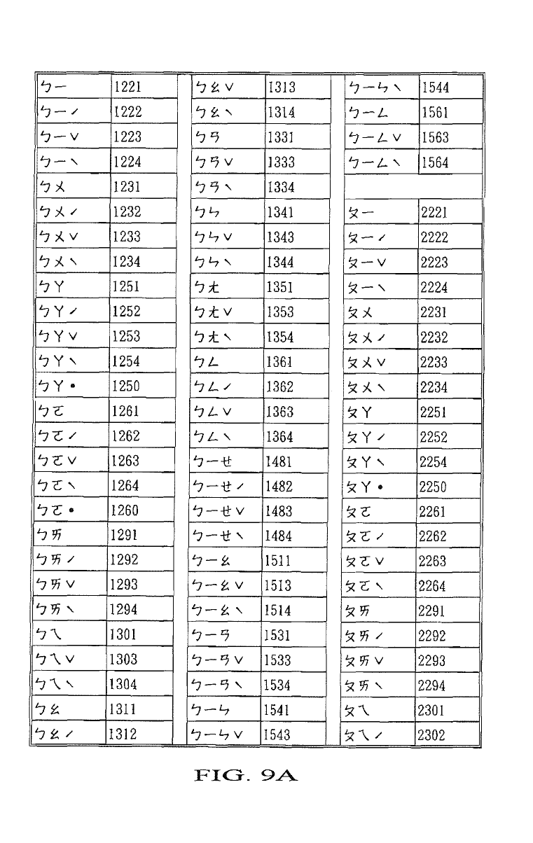

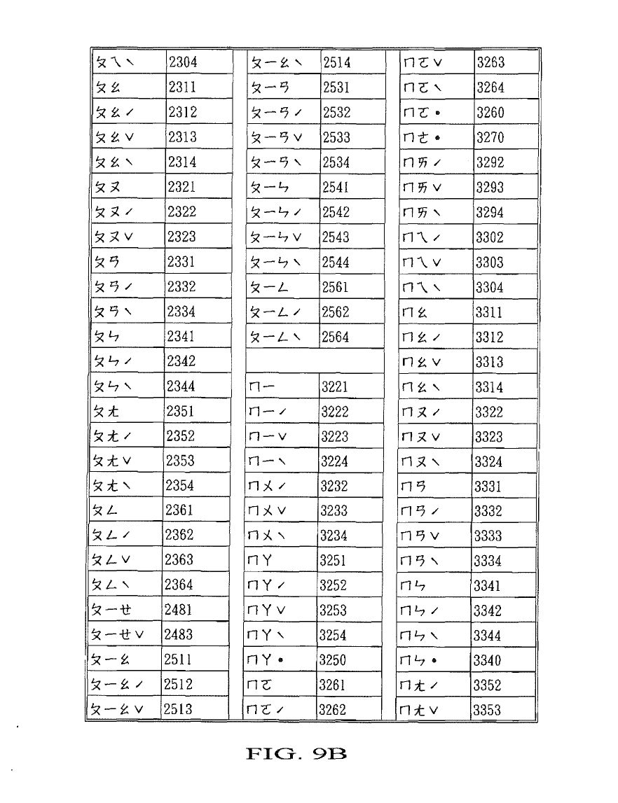

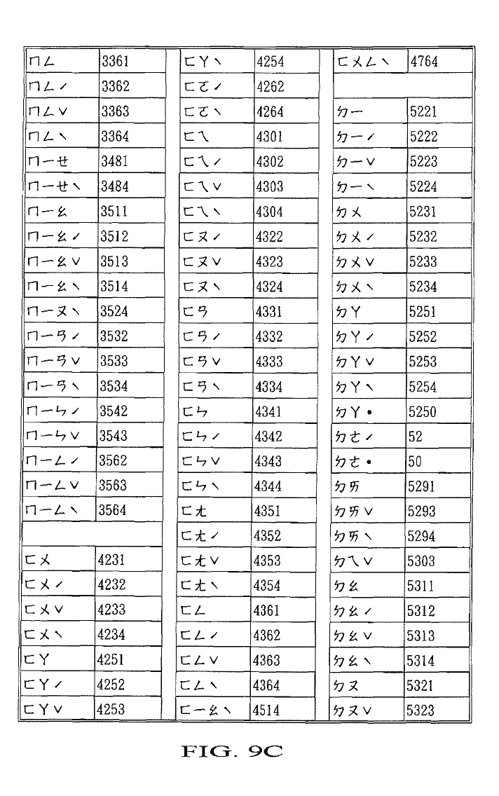

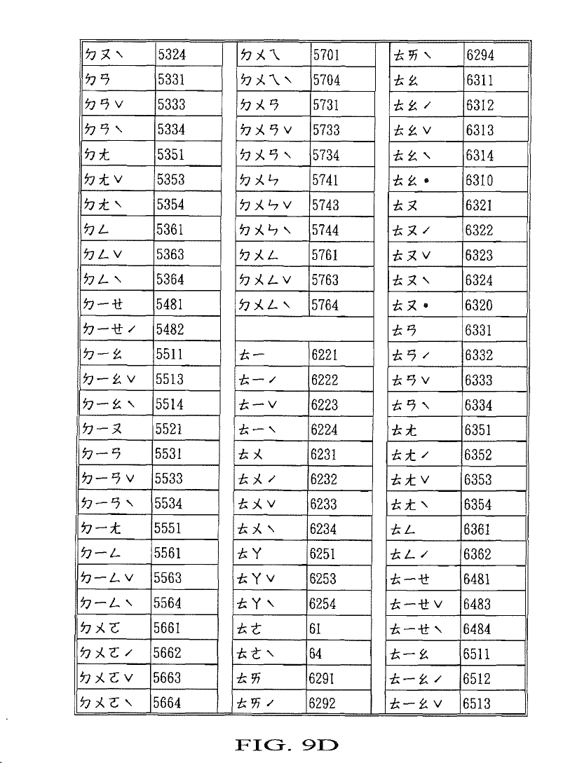

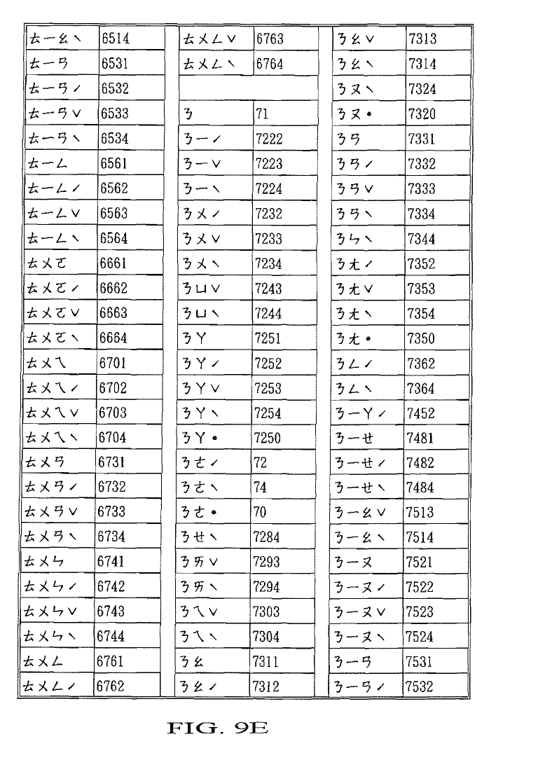

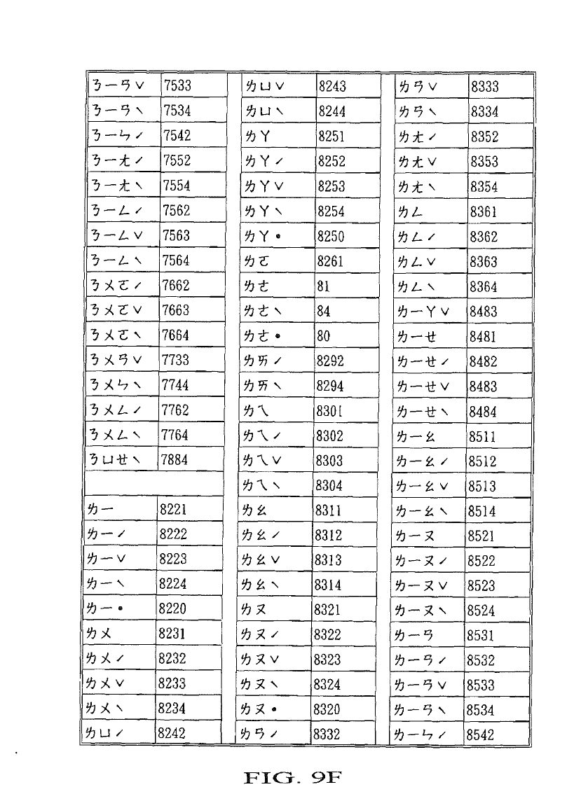

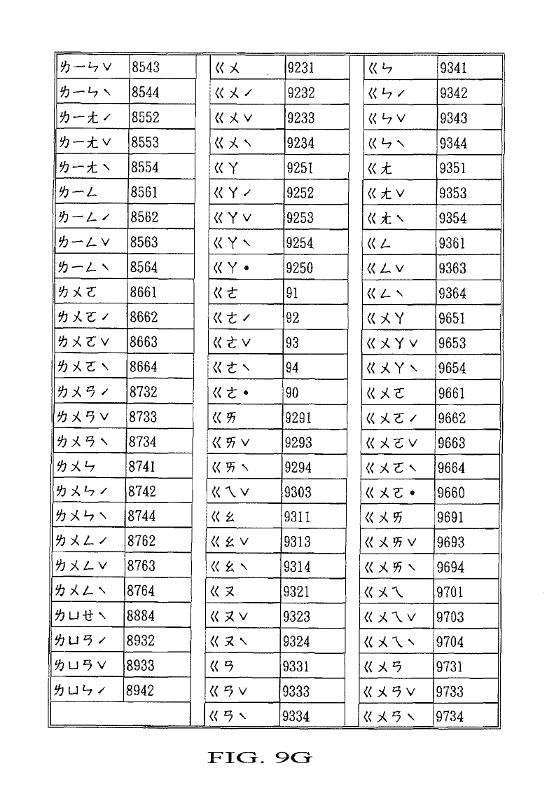

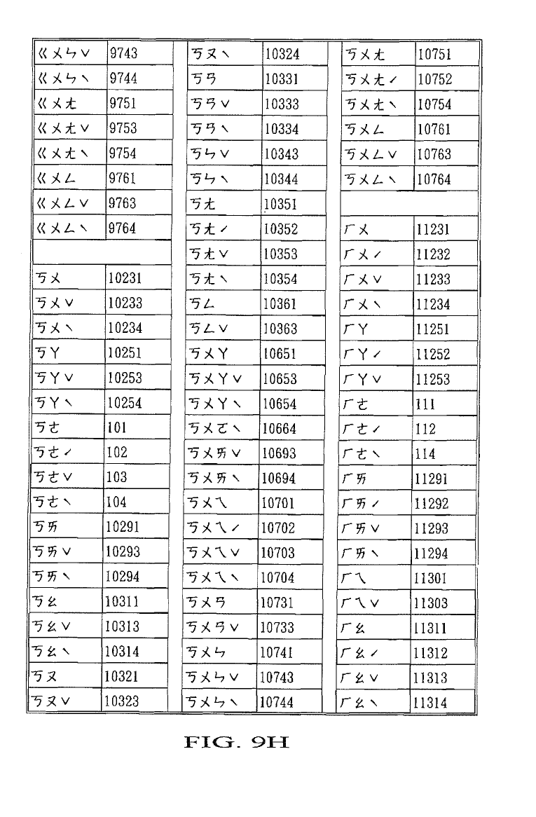

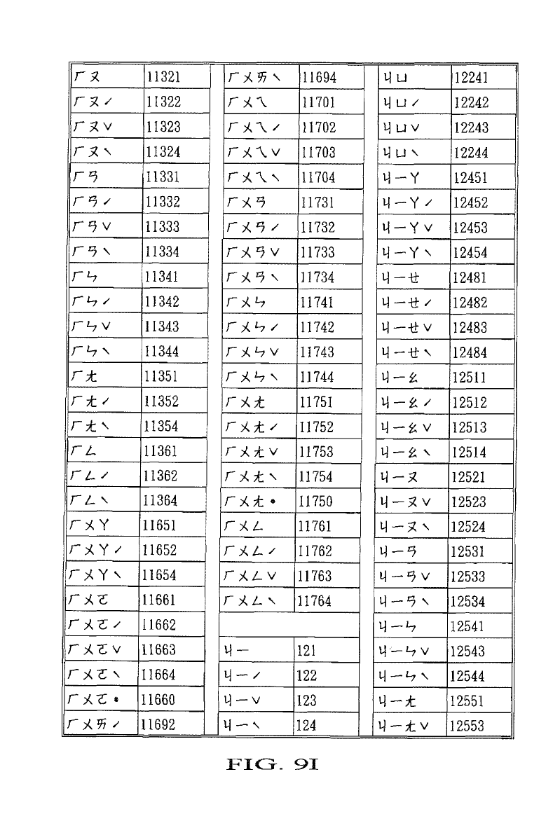

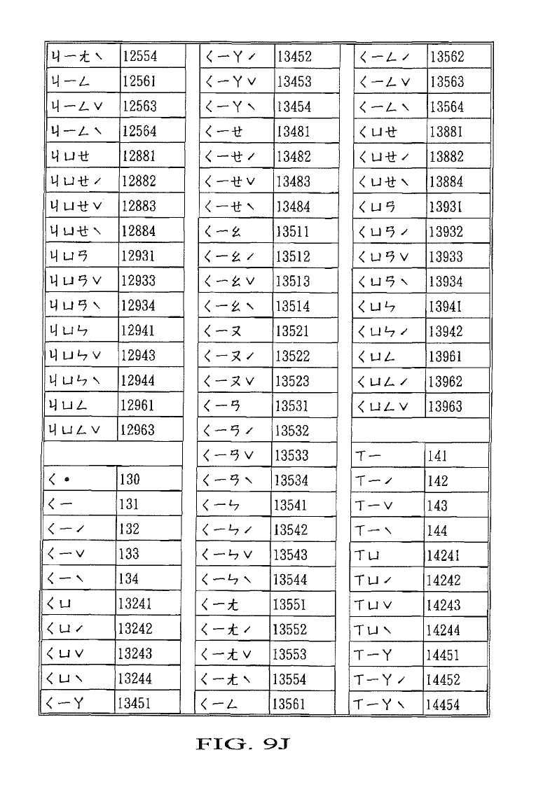

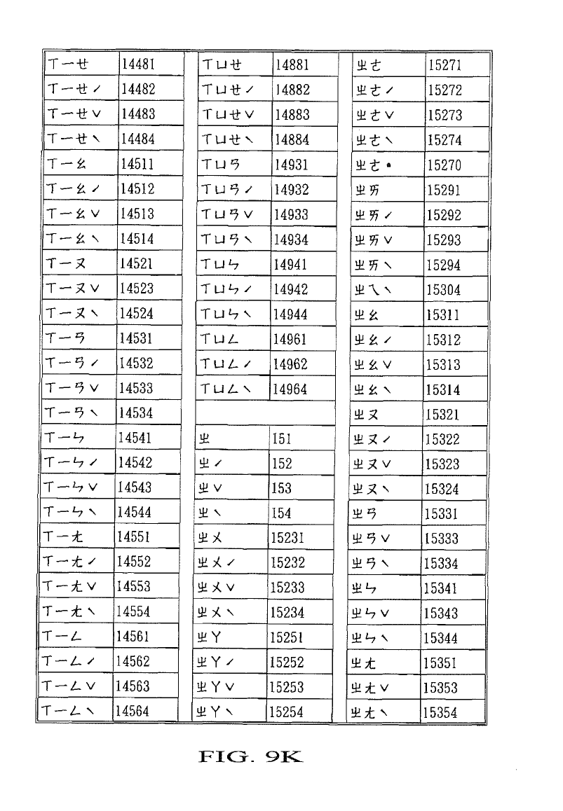

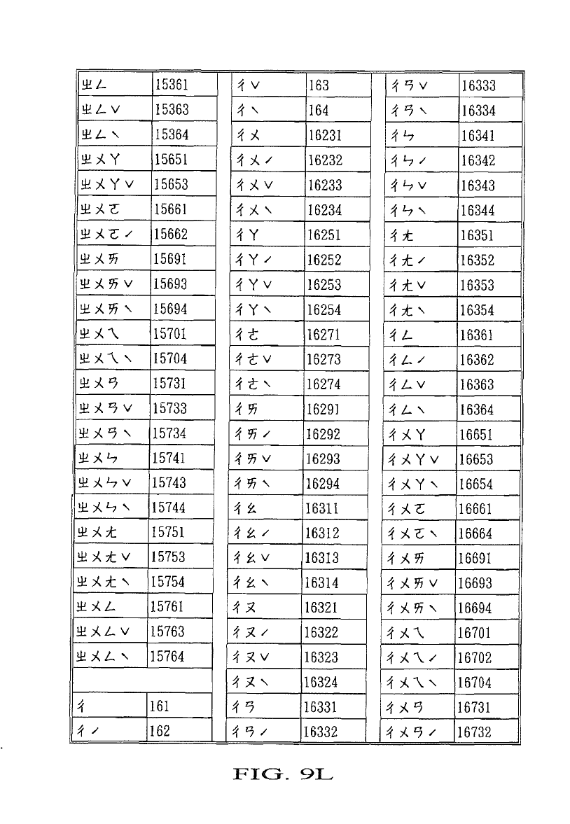

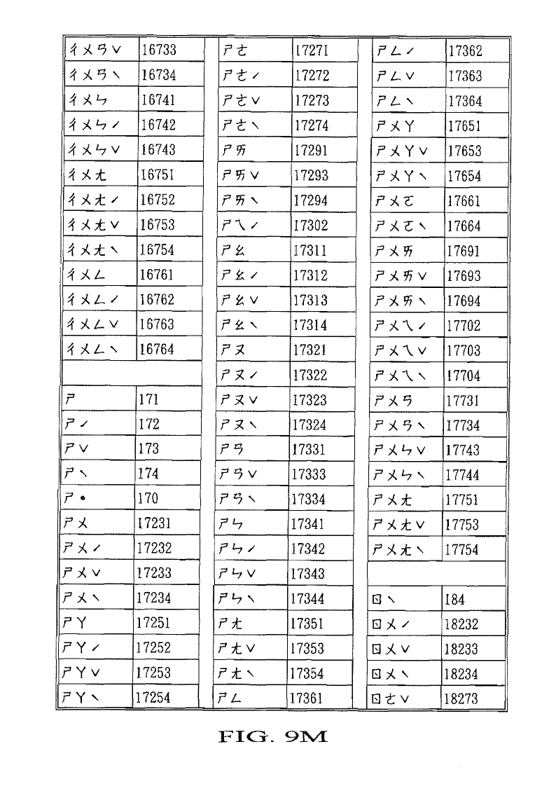

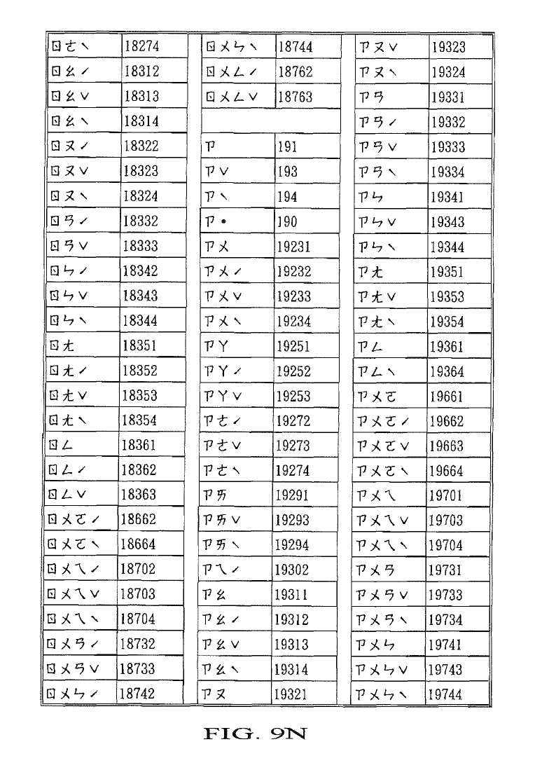

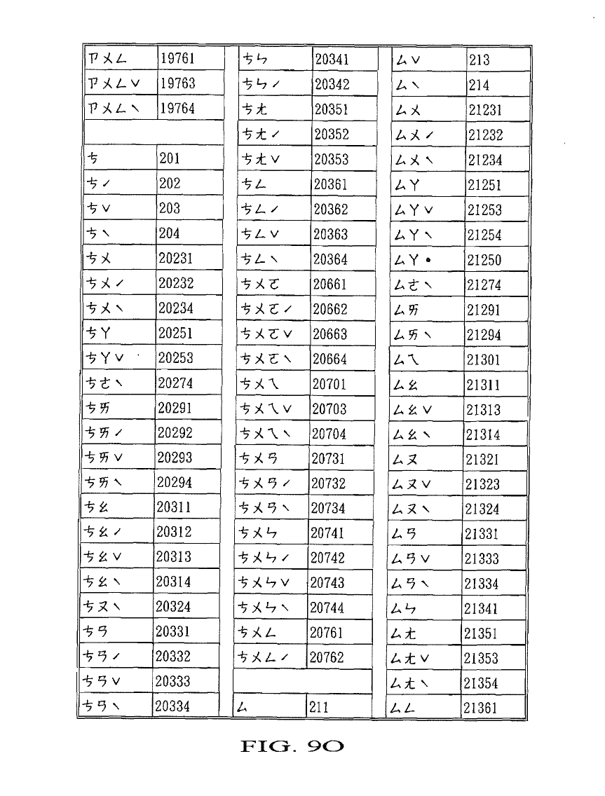

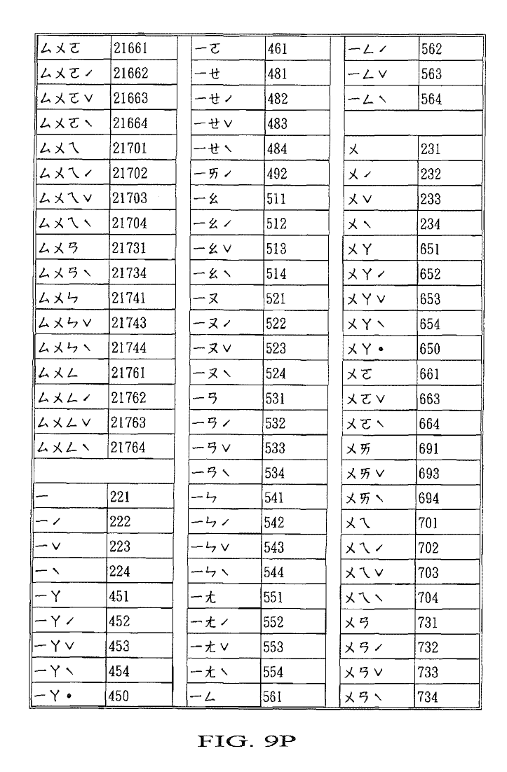

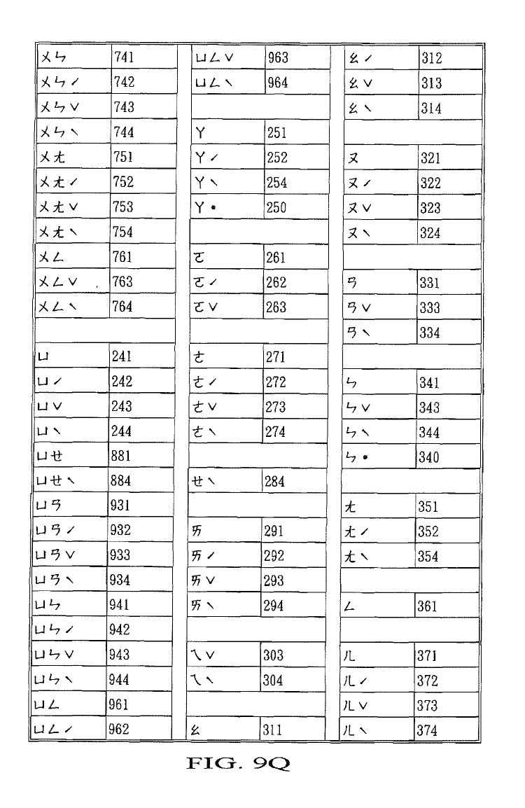

Referring to FIGS. 9A to 9Q, they are tables containing 1344 combinations of phonetic symbols, their tones, and codes according to the invention.

While the invention has been described in terms of preferred embodiments, those skilled in the art will recognize that the invention can be practiced with modifications within the spirit and scope of the appended claims.

What is claimed is:

1. A phonetic symbol based Chinese input apparatus for a computer comprising:
a main device;
a keyboard having a plurality of numerals each representing one of 0 to 9; and
a display;
wherein the main device includes a storage medium, and a piece of software for assigning entered phonetic symbols including a consonant, one of a rhyme and a compound rhyme, and a tone to a corresponding numeric string by using word prediction based on frequently used Chinese characters so that a corresponding Chinese character or Chinese phrase is shown on the display by keying in a minimum number of phonetic symbols.

2. The phonetic symbol based Chinese input apparatus of claim 1, wherein the storage medium is a data storage device and comprises a first Chinese characters output module having a plurality of phonetic symbols each corresponding to a Chinese character, a second Chinese characters output module having a plurality of phonetic symbols each corresponding to a phrase by using word prediction based on frequently used Chinese characters, and a Chinese characters data base.

3. A phonetic symbol based Chinese input method for a computer comprising the steps of:
(1) pressing a plurality of keys of a keyboard to enter a numeric string corresponding to a set of phonetic symbols wherein each of the keys represents 0, 1, 2, 3, 4, 5, 6, 7, 8, or 9;
(2) activating a piece of software to assign the set of phonetic symbols to a corresponding numeric string wherein the piece of software divides the corresponding numeric string into a symbol zone and a tone zone; wherein the symbol zone comprises one or two consonants, zero, one or two rhymes or zero, one or two compound rhymes; and wherein the tone zone comprises a tonal mark;
(3) activating a Chinese characters output module to receive the typed numeric string by using word prediction based on frequently used Chinese characters wherein the numeric string has numerals corresponding to the set of phonetic symbols;
(4) searching one or more corresponding Chinese characters from a Chinese characters database by comparing the set of phonetic symbols with phonetic symbols of each of a plurality of Chinese characters stored in the Chinese characters database;
(5) outputting the one or more corresponding Chinese characters if the searching is positive; and
(6) returning to step (1) to wait for input if no stop command is received.

4. The phonetic symbol based Chinese input method of claim 3, wherein the Chinese characters output module is stored in a storage medium and is configured to receive simplified codes corresponding to the set of phonetic symbols so that in response to keying in simplified codes, the piece of software assigns the corresponding set of phonetic symbols to a corresponding numeric string, and divides the corresponding numeric string into a symbol zone and a tone zone; the symbol zone comprises one or two consonants, zero, one or two rhymes or zero, one or two compound rhymes; the tone zone comprises a tonal mark; the piece of software searches one or more corresponding Chinese characters from the Chinese characters database by comparing the set of phonetic symbols with phonetic symbols of each of the Chinese characters stored in the Chinese characters database; and the piece of software outputs the one or more corresponding Chinese characters if the searching is positive.
